(19) United States
(12) Patent Application Publication
(10) Pub. No.: US 2016/0080958 A1
(43) Pub. Date: Mar. 17, 2016

(54) LOGGED MEASUREMENTS

(71) Applicant: NOKIA TECHNOLOGIES OY, Espoo (FI)

(72) Inventors: Mika Rinne, Espoo (FI); Carl Wijting, Espoo (FI); Sami Johannes Kekki, Helsinki (FI); Mikko A. Uusitalo, Helsinki (FI); Niko Kiukkonen, Veikkola (FI); Antti Sorri, Helsinki (FI)

(21) Appl. No.: 14/786,018

(22) PCT Filed: Apr. 24, 2013
(86) PCT No.: PCT/US2013/038062

§ 371 Date: Oct. 21, 2015

(51) Int. Cl. H04W 24/10

(52) U.S. Cl. CPC H04W 24/10; H04W 84/12

(57) ABSTRACT

Methods and apparatus, including computer program products, are provided for reporting WLAN-related information. In one aspect there is provided a method. The method may include receiving, at a user equipment, a request from a cellular radio access network to obtain information about a wireless local area network, wherein the request comprises at least one of a logged measurement configuration, a measurement configuration, or a trace procedure; and reporting, in response to the request, at least one of a measurement representative of a wireless local area network access point, a load experienced by the wireless local area network access point, or a capacity experienced by the wireless local area network access point. Related apparatus, systems, methods, and articles are also described.

### FIELD

The subject matter described herein relates to wireless communications.

### BACKGROUND

Interworking refers to the ability of different types of networks, such as HetNets, or nodes therein to work together. Wireless local area networks (WLANs) are becoming increasingly prevalent, so mobile network operators may also increasingly seek to exercise control or coordination over wireless local area networks to improve user experience and to provide better access service.

### SUMMARY

Methods and apparatus, including computer program products, are provided for reporting WLAN-related information. In one aspect there is provided a method. The method may include receiving, at a user equipment, a request from a cellular radio access network to obtain information about a wireless local area network, wherein the request comprises at least one of a logged measurement configuration, a measurement configuration, or a trace procedure; and reporting, in response to the request, at least one of a measurement representative of a wireless local area network access point, a load experienced by the wireless local area network access point, or a capacity experienced by the wireless local area network access point.

In some variations, one or more of the features disclosed herein including the following features can optionally be included in any feasible combination. The information may include at least one of the following: an idle channel measurement; beacon information obtained by listening to a beacon associated with the wireless local area network access point; report information obtained from the wireless local area network access point; and at least one statistic representative of the wireless local area network access point. The information may be obtained in accordance with a station functionality of a wireless local area network. The reporting may be performed periodically, on demand when requested, on a trigger of an event, or a combination thereof. The request may include a radio resource control connection reconfiguration message including at least one instruction for the user equipment to obtain the information about the wireless local area network access point. The radio resource control connection reconfiguration message may include a measurement priority. The user equipment, operating as a station, may obtain the information about the wireless local area network access point. The cellular radio access network may provide an identity for the wireless local area network access point. The cellular radio access network may provide at least one of a frequency band or a radio access technology representative of candidate wireless local area network access points. The reporting may further include at least one of a delay associated with the wireless local area network access point, a throughput associated with the wireless local area network access point, a backhaul load associated with the wireless local area network access point, and a backhaul offered bit rate associated with the wireless local area network access point. The wireless local area network access point may include a plurality of wireless local area network access points.

The above-noted aspects and features may be implemented in systems, apparatus, methods, and/or articles depending on the desired configuration. The details of one or more variations of the subject matter described herein are set forth in the accompanying drawings and the description below. Features and advantages of the subject matter described herein will be apparent from the description and drawings, and from the claims.

### DESCRIPTION OF DRAWINGS

In the drawings,

FIG. 1 depicts an example of a system configured to handle interworking, in accordance with some exemplary embodiments;

FIG. 2 depicts example processes for logging measurement reports to obtain by a user equipment wireless local area network information, in accordance with some exemplary embodiments;

FIGS. 3-4 depict example processes for obtaining by a user equipment wireless local area network information, in accordance with some exemplary embodiments;

FIG. 5A depicts another example process for obtaining by a user equipment wireless local area network information based on minimization of drive testing procedure, in accordance with some exemplary embodiments;

FIG. 5B depicts another example process for obtaining by a user equipment wireless local area network information, in accordance with some exemplary embodiments;

FIG. 6 depicts an example of a user equipment, in accordance with some exemplary embodiments; and

FIG. 7 depicts an example of a base station, in accordance with some exemplary embodiments.

Like labels are used to refer to same or similar items in the drawings.

### DETAILED DESCRIPTION

In some example embodiments, there is provided a radio access network level mechanism for interworking or integration between a cellular radio access network (RAN) and a wireless local area network (WLAN). For example, the subject matter disclosed herein may, in some example embodiments, provide so-called “loose interworking” in the sense that there is no required tight handover procedure between the cellular radio access network, such as a long term evolution (LTE) RAN and the like, and a WLAN access network, such as WiFi access network and the like, but rather the loose internetworking may provide, in some example embodiments, a configured radio access selection based on a set of criteria/requirements.

In some example embodiments, the user equipment (UE) may be configured to operate as both a UE operative with a cellular network and operative as a WLAN station (STA), so the UE can acquire information from WLAN networks, hotspots, access points, and this acquisition may be based on genuine mechanisms available to the STA in the WLAN access network. Moreover, the cellular radio access network (RAN), such as an LTE RAN, may set requirements/criteria, which may comprise preferences, for logged measurements. In addition, the cellular radio access network may set the requirements by for example sending to the UE a request, such as a logged measurement WLAN request (for example, LoggedMeasurement_WLAN-request). Once the UE acting as a STA in a selected WLAN network(s) has collected the requested logged measurement information, the UE may then respond, in some example embodiments, by sending to the cellular radio access network a response, such as a logged measurement WLAN report (for example, LoggedMeasurement_WLAN-report). Logged measurement procedures may be in use for the minimization of drive tests to acquire radio access information for the sake of network optimization, for the purpose of better serving the population of user equipment stations in the network, and/or to address a problem behavior of a user device in a given occurrence.

In some example embodiments, the response from the UE to the cellular radio access network may comprise a report including information, and this information may include measurements of one or more WLAN access points, WLAN networks, other WLAN STAs, and/or other WLAN-related information (for example, provided by an access control server or an authentication server). According to some example embodiments, the logged measurement report includes at least one WLAN-related information/measurements, rather than only cellular network related information/measurements. For example, the logged measurement WLAN report sent by the UE to the cellular radio access network may include one or more of the following WLAN-related information: UE/STA idle channel measurements of the WLAN; information that can be obtained from a selected WLAN access points or WLAN networks by listening to beacons, other WLAN reports (which may be available for example from an access control server or a data collection of an access point or a network), and/or a defined request response procedure; information that can be measured while operating for a given time over active traffic links in a selected WLAN; uplink and/or downlink load for a selected WLAN; uplink and/or downlink capacity for a selected WLAN; and/or a backhaul capacity for a selected WLAN (which may be obtained by running a hotspot protocol whose Access Network Query Protocol (ANQP) may for example deliver the backhaul bit rate in a Wireless Access Network (WAN) metric information element).

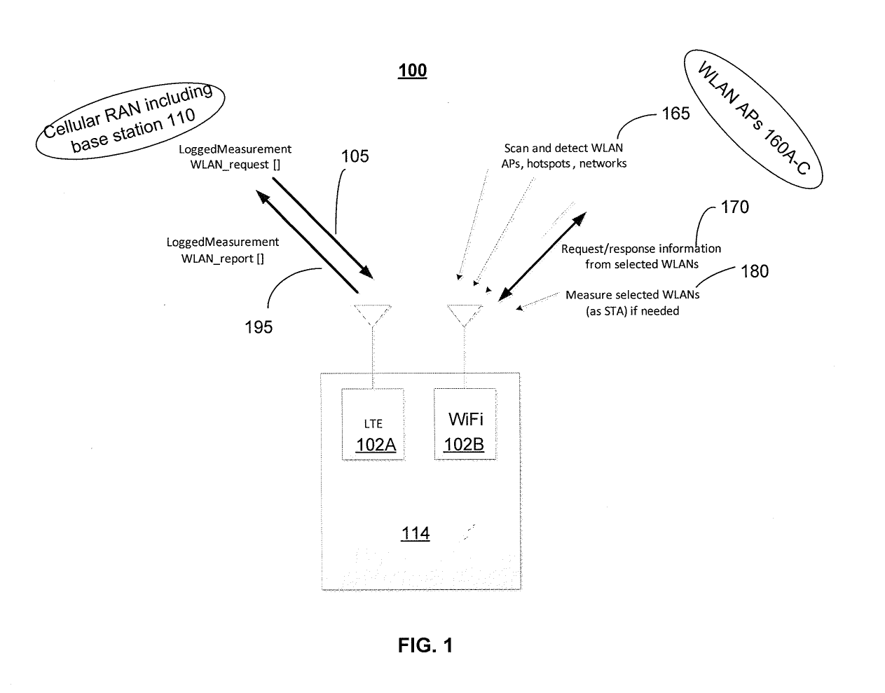

FIG. 1 depicts an example of a UE 114, in accordance with some example embodiments. The UE 114 may include a plurality of radio access technologies, such as a long term evolution (LTE) 102A and WiFi 102B. Although FIG. 1 depicts LTE 102A and WiFi 102B at UE 114, other cellular radio access technologies and wireless local area radio access technologies may be used as well. UE 114 may operate with a cellular RAN 110, such as an LTE radio access network and the like, and operate as a STA configured to operate with a wireless local area network including access points 160A-C. In the example embodiment of FIG. 1, UE 114 may be configured by the LTE RAN 110 via a request, such as a logged measurement WLAN request 105, to report WLAN-related information including measurements from WLAN networks 160A-C(which may be selected or preferred by the LTE network and/or UE). The UE 114 operating as a STA in the WLAN may obtain WLAN-related information including measurements and the like. For example, the UE 114 may operate like a STA to scan and detect WLAN APs and the like 165, request and receive information from WLANs 170, and/or measure WLANs 180. The obtained WLAN-related information requested by the cellular network (which in this example is an LTE RAN) may then be reported at 195 to the cellular network using, for example, the logged measurement report 195.

In some example embodiments, UE 114 may gather WLAN-related information, such as for example, WLAN statistics, WLAN quality experiences (for example, prior successful attempts, prior unsuccessful attempts, and/or other past experiences with a WLAN AP), and/or WLAN load measures from an available WLAN AP obtained via genuine WLAN mechanisms (for example, gathered in a manner consistent with a STA). The gathered WLAN-related information may then be reported to the cellular RAN in a radio resource control (RRC) logged measurement report, in some embodiments. In some example embodiments, the RRC logged measurement request and report may be pre-defined. Table 1 below depicts an example of a predefined RRC logged measurement request sent to the UE 114, and Table 2 depicts an example of an RRC logged measurement report sent by the UE 114 to the cellular RAN, such as an LTE RAN, in response to the request of Table 1. The UE 114 may collect requested observations over a longer time period and report them at once, at an event triggering, and/or at a time when convenient if not time critical. Alternatively or additionally, UE 114 may be requested to obtain the information immediately and report as soon as available.

When the cellular RAN receives the RRC logged measurement report sent by UE 114, the cellular RAN may execute an action based on received report. For example, the cellular RAN may adjust/tune its parameters to better serve the UE; the RAN may decide to guide a specific UE to a selected WLAN AP according to recommendations or preferences of the LTE RAN and/or the recommendations or preferences of the UE; and/or the LTE RAN may decide to offload some traffic types to the WLAN to better serve one or more UEs having a certain type of traffic, such as a critical traffic type or a traffic type of a critical user. The cost/price of access to a user may also impact decisions, such as whether to direct the UE to the WLAN access or not, and/or whether to direct the UE to one specific WLAN access service set or another one of the available service sets.

In some example embodiments, subscription information, load information, traffic selection by the UE and/or user preferences may act as triggers for WLAN selection. For example, given a roaming partner network, the cost of network access may be a trigger for selection of an alternative access network at a given location.

Furthermore, when a multipath protocol, such as multipath TCP, is configured over a first access path from the UE to the cellular RAN and a second access path from the UE to the WLAN, measurements may also be performed over the two access paths of the multipath legs. This multipath measurement may provide an indication of concurrent operation over the two access paths in terms of measurements, such as throughput, delay gains, power consumption, and the like. These measurements may be collected per TCP multipath leg (or combined over the legs) and then reported to the cellular RAN (for example, in a report like Table 2). This kind of TCP information may serve as a multipath TCP evaluation, such as an indication of whether it is preferable to execute over one or both of the wireless access paths.

TABLE 1
Example of a LoggedMeasurement_WLAN-request

```
LoggedMeasurement_WLAN-request {
    Timing info
    network identities or preferences
    trace-identity
    trace recording session reference
}
```

The information elements of Table 1 may include a service set identifier of a selected or preferred WLAN network, hotspot, and/or access point (for example, service set identifiers (SSID), basic service set identifiers (BSSID), homogeneous extended service set identifier (HESSID) of the WLAN network, hotspot or access point). In the case of a mesh network, the basic service set (MBSS) may be identified if considered relevant. The reported information element may also precisely include the AP Ethernet media access control (MAC) addresses, which uniquely identifies each one AP of an access network, for example it may identify a home WLAN. The MAC address may be helpful in some instances because home WLAN AP at a given MAC address may be regularly used for access attempts by the UE, so it may be beneficial to know that the access point in selection is specifically the home WLAN AP. The reported information may include an identifier of a Trace (for example, an identifier and session reference) in case the device is tracing several different metrics in its Logged Measurements or if the device is tracing different sessions separately to a different measurement trace. The trace time may also be separated in the report so that a trace of a measure can be compared on a daily or weekly basis.

TABLE 2
Example of the LoggedMeasurement_WLAN-report (or response)

```
LoggedMeasurement_WLAN-report {
    Timing info [timestamp]
    trace-identity
    trace recording session reference
    Opt: idle channel measurement report
    Opt: WLAN information [#of WLAN networks]
}
```

Referring to Table 2, the idle channel measurement report may include WLAN measurements of noise or interference levels in a state when the WLAN channel was sensed to be idle or in a state when the WLAN channel was indicated as idle. The WLAN report information may include a time stamp, a service set identifier of the selected WLAN network, hotspot or an access point, trace information including session, and WLAN-related information. The measured WLAN access point(s)'s Ethernet MAC address(es) may also be available in the report of Table 2. If the LTE RAN has more specific information about a preferred or selected WLAN AP within a given coverage area and/or if there is a specific measure that the RAN network uses for the decision to offload UEs or traffic types to a given WLAN, the requested WLAN report objects may be limited to include only those specific information or metrics (for example, a backhaul bit rate only measurement, the obtained average delay of all STAs served by the access point, the obtained average throughput over the served stations), or the specific information/metric may be specifically requested by the network.

Requesting reports and measures of a WLAN as a STA (for example, via a genuine WLAN procedure) may have the benefit, in some example embodiments, that the measures that are available by the AP are collected or averaged over time or over other STAs, and the reportable results are readily available without long observation periods required by the reporting STA/UE itself. The UE may, if so preferred, do further comparison or filtering of the obtained WLAN information/metrics. UE may also decide leave out some of the measures provided by the AP and to only include relevant information in the LoggedMeasurement_WLAN-report. This information may be formed by for example comparing information provided by the AP to thresholds set by a policy, such as a traffic routing policy or defined preference thresholds. As such, the UE/STA may only report a measure if it appears relevant for a choice. For example, if the UE has been requested to provide information from more than one network and if the UE acquired information from three WLAN APs having different networks service set identifiers (SSID), the UE may decide to report only the best WLAN AP, decide to report only the two best access points out of three, and/or report measurement information from all of the WLAN APs to the cellular RAN.

The logged measurement report (for example, LoggedMeasurement_WLAN-report) may include one or more objects, examples of which are described below with respect to Tables 3-9.

For a given WLAN including a hotspot or a WLAN AP, the logged measurement report may include a load measurement object. For example, load metrics may be reported in accordance with Table 3. The load metrics may include a frame parameter representative of channel traffic received at the UE/STA, channel utilization, a noise histogram, and/or any other parameters including statistics indicative of the load at the WLAN AP.

TABLE 3

Load metrics {
Frame; returns a measure of all channel traffic and count of all frames
received at a STA
Channel load ; channel utilization observed by the measuring STA
Noise histogram ; power histogram observed by sampling the channel
while carrier sense indicates idle

The UE/STA may average statistics collected by the WLAN AP, and the averages may be reported in accordance with the object depicted at Table 4. The statistics may include for example average access delay, transmitted fragments count, failed counts, success counts, and/or transmit stream per traffic category measurement (which may represent quality). Secondary momentum of statistics may also be included in the report, such as fractiles, 5%-ile, 25%-ile, 75%-ile, 99%-ile, and the like (for example, an access network providing better 25%-ile of metrics may be favored over one having a better average).

TABLE 4

```
STA statistics{
    Average access delay
    Transmitted fragments count
    Failed counts
    Success counts
    Transmit stream per traffic category measurement (quality)
}
```

Table 5 depicts an object including statistics collected by the WLAN AP averaged according to criteria over the served STAs. The statistics may include basic service set (BSS) statistics, such as BSS average access delay, BSS average access delay per access category, BSS channel list, BSS channel utilization, location, and the like.

TABLE 5

```
BSS statistics {
    BSS average access delay
    BSS average access delay per access category
    BSS channel list
    BSS channel utilization
    Location
}
```

Table 6 depicts an object including statistics obtained from a WLAN AP from neighboring access points of the same basic service set.

BSS neighbor report {
Neighbor report table [# set of neighbor APs]
}

Table 7 depicts an object including statistics of the UE/STAs experience over the device-to-device links.

Device-to-device report {
Link quality of STA to STA traffic
}

Table 8 depicts an object including additional Information elements, which may be included when Hotspot 2.0 based queries are available and can provide information for example defined by the ANQP protocol or its future extensions.

TABLE 8

Hotspot 2.0 ANQP provided information {
Hotspot name (HESSID)
Location (area code, geo)
Backhaul bit rate ( )
Measured / nominal bit rate ( )
}

The UE may collect throughput history (for example, experiences) while connected to a WLAN and/or over cellular RAN/LTE sessions (which were switched from the LTE to WLAN or vice versa). This throughput history may be used as WLAN-related information and be provided as part of the logged measurement report, an example of which is depicted in Table 9 below. Examples of metrics include delay for a given flow type, which may include average delay, relative delay between LTE and WLAN access, deviation in delays between radio access, and power efficiency ratio between the LTE RAN and the WLAN RAN. As an example, this WLAN-related information may also be subjective by some measure, if it is perceived as excellent, good, satisfactory, poor, and the like.

TABLE 9

```
LTE_WLAN report {
Averaged LTE tp ( ), delay ( ) for a flow type
    Averaged WLAN tp ( ), delay ( ) for a flow type
    Relative LTE/WLAN tp ( ), delay ( )
    Deviation of tp ( ), delay ( ) between radio access
    Power efficiency LTE/WLAN ratio ( )
}
```

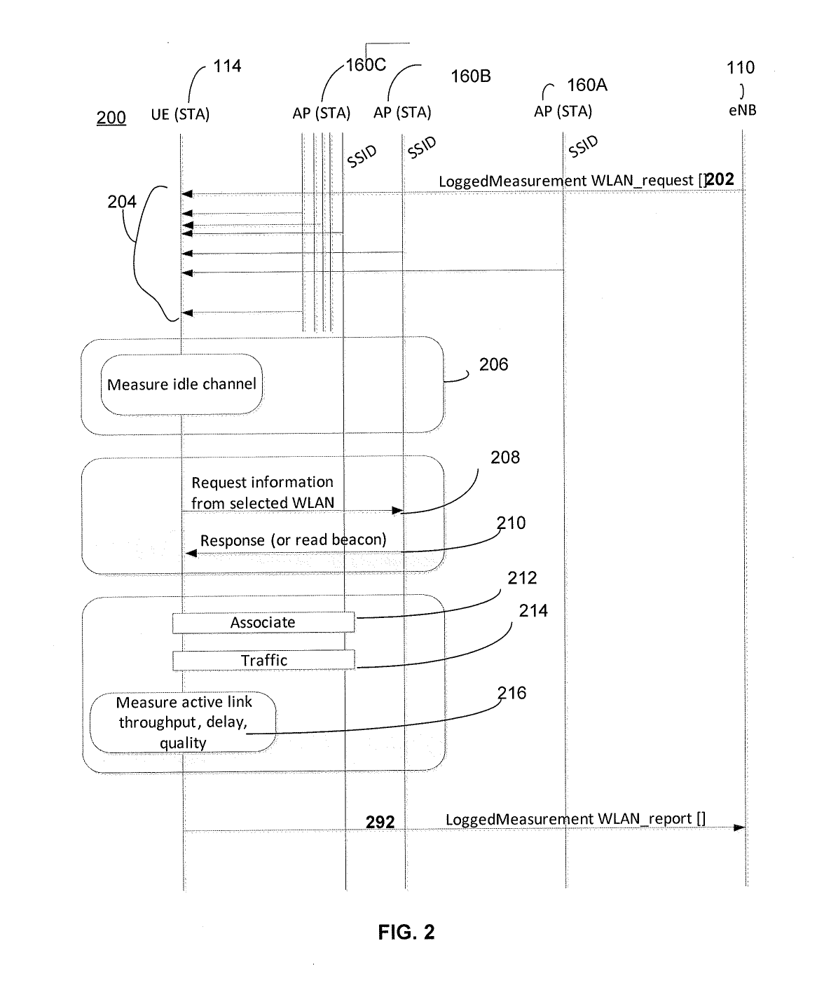

FIG. 2 depicts an example process 200, in accordance with some example embodiments.

At 202, the cellular network, such as an LTE RAN including an eNB base station 110, may send a request, such as a logged measurement WLAN request (202) to UE 114. The request may trigger the UE to obtain and/or report to the cellular network WLAN-related information including measurements. This report may comprise a logged measurement WLAN report, which is sent at 292. The UE 114 may access one or more WLAN access points 160A-C as depicted at 204, and this access may be performed in the same way a WLAN STA would access WLAN access points 160A-C, in accordance with some example embodiments. At 206, the UE 114 may obtain (for example, in a manner in accordance with a STA) information and/or measure the WLAN APs, in accordance with some example embodiments. These measurements may include for example measurements of an idle channel, although other types of measurements of the WLAN APs may be performed as well. At 208, the UE 114 may also request (for example, in a manner in accordance with a STA) information from a given WLAN and receive the WLAN-related information at 210, in accordance with some example embodiments. In some example embodiments, the UE 114 may also associate itself with a WLAN, such as WLAN 160C, at 212, initiate active traffic with the WLAN as depicted at 214, and then measure the active link (for example, throughput, delay, quality, and the like) as depicted at 216. The WLAN-related information including measurements obtained by UE 114 at 206-216 may then be reported to the network via logged measurement report 292, in accordance with some example embodiments.

In some example embodiments, a report from the WLAN can be obtained, as noted, by a request/response procedure for the WLAN-related information including measurements collected by the WLAN APs or the UEs (for example, operating as non-AP STAs). These reports, such as the logged measurement report noted above, may contain experiences of the WLAN AP, experiences of other STAs having had association to the WLAN AP, or statistics averaged over sessions (or packets of many STAs). When the LTE network expects a given UEs assessment/perception of the WLAN, it may be obtained by making additional measurements (for example, about the interference and power levels in the location of the UE/STA). Other measurements, such as quality and traffic performance related information/measurements, may be obtained by associating to the WLAN AP, and utilizing the WLAN AP for a given time to perform measurements of the traffic, providing measures for delay, load, throughput, and the like that can be collected as they would be experienced by the UE/STA.

The following describes some additional example embodiments related to radio resource management related to WLAN internetworking. Specifically, when a cellular network, such as an LTE RAN and the like, considers a WLAN AP as a potential target for mobility related activities or traffic steering related activities, the WLAN AP may also become a target of measurements, such as signal strength. But signal strength alone may not provide sufficient information for a reliable handover decision. This may be due in part to a lack of an interface between the cellular radio access technology (RAT) and the WLAN radio access technology to allow proper admission control in the target node before a mobility event, such as a handover and the like. For example, a WLAN AP may have sufficient signal strength but due to for example a high load in the WLAN AP (or the WLAN's backhaul link), the connection quality at the WLAN AP may not be sufficient to support another device handed over to the WLAN AP. Moreover, the WLAN AP having sufficient signal strength may not be a favorable selection belonging to another network or having backhaul to a less trusted network domain. As such, it may be beneficial, in some example embodiments, for a radio resource management entity in the cellular RAN to have information about the WLAN AP's load, backhaul load, and the like. To that end, some of the embodiments disclosed herein may relate to how a user equipment can be used to relay WLAN-related information (for example, load information and the like) needed by the cellular RAN for admission control can be provided to the cellular RAN including a radio resource management (RRM) entity where mobility decisions are made.

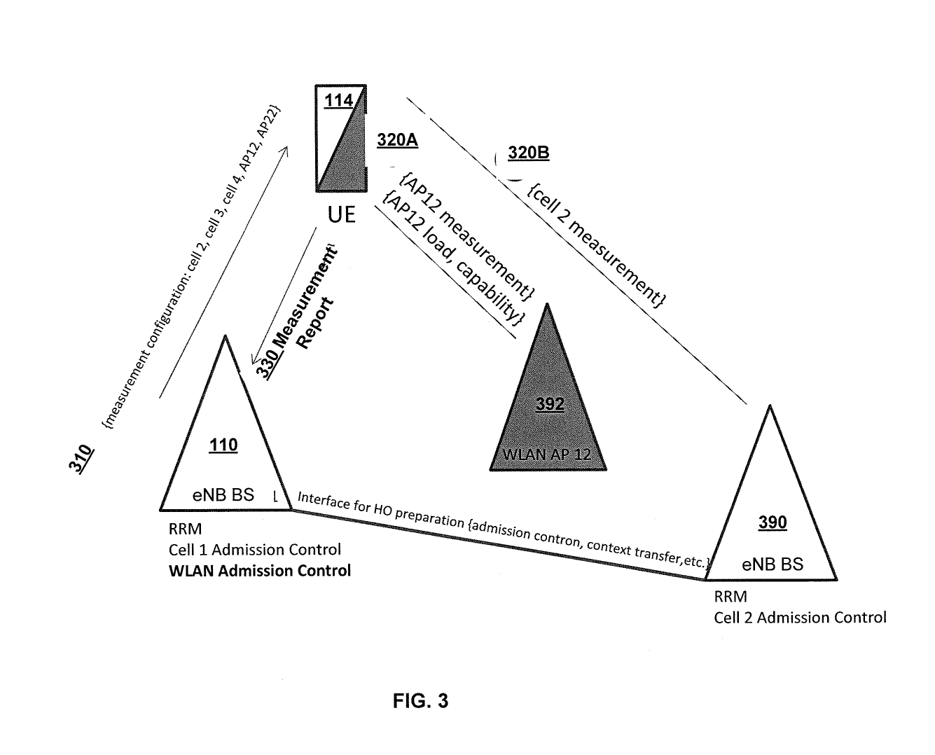

FIG. 3 depicts a cellular RAN including a node therein, such as an evolved NodeB base station 110 (although other types of access points and base stations may be used as well) sending at 310 a measurement configuration to UE 114, in accordance with some example embodiments. This configuration may identify one or more access networks, such as include another cellular cell 2 at 390 and a WLAN access point 12 at 392. Accordingly, UE 114 may at 320A measure WLAN access point 392 and obtain other WLAN-related information, such as WLAN access point load information including backhaul load and/or capacity, uplink/downlink load and/or capacity to/from WLAN AP, as well as other WLAN-related information. The UE 114 may at 320B perform other measurements of the other cellular RAN 390. At 330, UE 114 may then report the measurements and information obtained at 320A-B, and this report may be sent to the cellular RAN including eNB base station 110 (which requested the measurements at 310) to allow the cellular RAN including eNB base station 110 (or another node in the cellular radio access network) to make admission control decisions, such as a handover or mobility decision to a WLAN AP 392 and/or cell 390.

In some example embodiments, UE 114 may measure the signal quality of the WLAN APs and acquire information from the WLAN AP via information elements, such as WLAN AP load, connection capability, and other metrics as well. In some example embodiments, a basic subscriber set (BSS) load information element in accordance with IEEE 802.11 may be used to obtain load information from a WLAN AP, although the load information may be obtained in other ways as well. Moreover, the information elements, such as WAN metrics, connection capability, and any other information elements, may be acquired by a query of the WLAN AP(s). The UE 114 may send the measurements, acquired WLAN AP information, and corresponding identifiers for the WLAN associated with the measurements/information to the cellular RAN 110. Moreover, the UE may send this information in a measurement reporting message sent at 330.

When WLAN APs are available for use by a cellular network, the cellular network may, in some example embodiments, provide to a UE the relevant WLAN AP identifiers and/or the frequency band information for those APs. This information may be provided in a measurement configuration sent to a UE. When this information is received by a UE, the corresponding WLAN APs included in the measurement configuration may then become targets for measurements by a UE in any given cell where there are known WLAN APs.

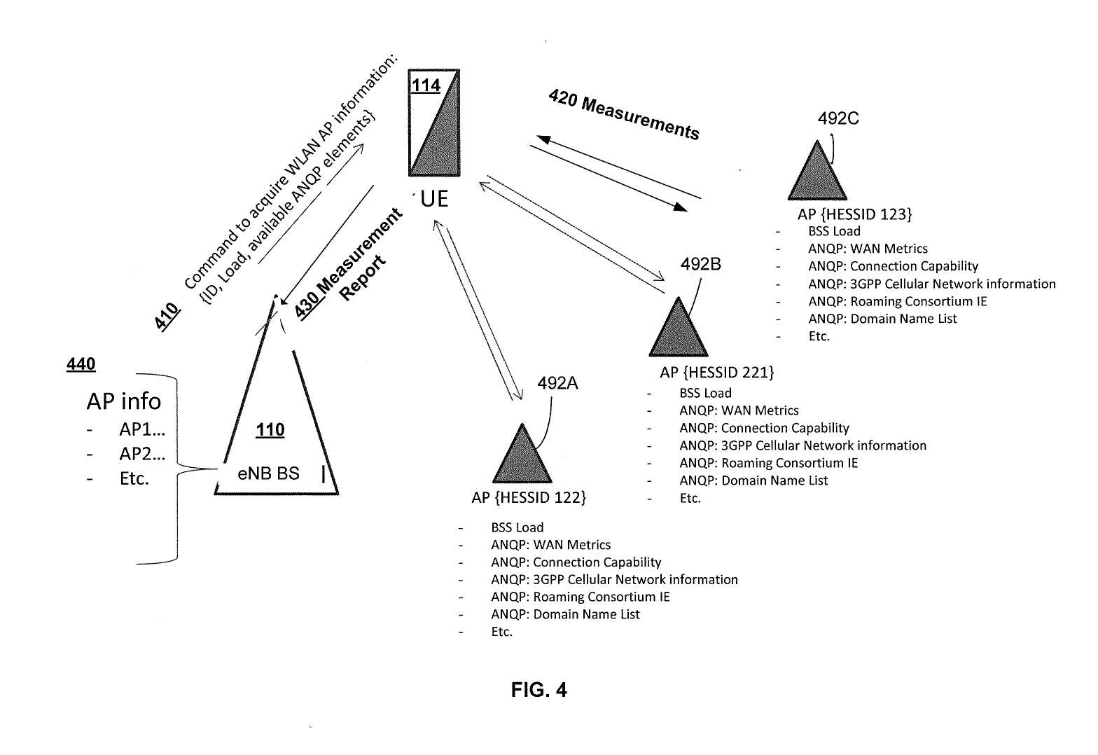

FIG. 4 depicts an example embodiment in which the WLAN radio access technology is specified by the cellular network as a new target for measurements by a UE, without specifying the specific identities of the WLAN AP (which is the case in the example of FIG. 3). In the example embodiment of FIG. 4, the cellular network including eNB base station 110 may learn the WLAN APs available in any specific location. Specifically, the UE 114 may receive a request, such as command 410, to acquire WLAN AP information, such as identifiers, measurements, load, and the like. The UE 114 at 410 may then measure available access points including WLAN APs in its vicinity and report at 430 the results back to the cellular network/eNB base station 110, along with the WLAN AP identifiers of the discovered WLAN APs discovered. In this example embodiment, the cellular network (for example, a radio resource manager entity and/or another node therein) may acquire the information at 440 related to the WLAN APs near UE 114 and the capability of those WLAN APs. The cellular RAN (or for example, a radio resource manager (RRM) entity and/or another node therein) may then perform admission control for the UE 114 and enable access to one or more of the WLAN APs 492A-C.

In some example embodiments, a node in the cellular network, such as a RRM entity at for example an evolved NodeB base station may maintain the load level status of the WLAN APs based on the measurement reports received at 430 from one or more UEs. Depending on the RRM algorithm used and the variability in WLAN APs load and the like, the above noted WLAN load information may be requested less frequently than the actual signal strength measurements from the WLAN AP. For example, the request for reporting of the WLAN AP load, WAN metrics, connection capability and any other relevant WLAN-related information available in the WLAN AP (for example, in its beacon or via ANQP mechanism) may be commenced based on an explicit request, when needed.

In some example embodiments, the RRM node may then use its WLAN AP related information (for example, load and the like) as a factor in active mode mobility decisions made at the RRM node and/or as a factor in controlling the behavior of idle mode UEs in inter-radio access technology cell re-selection. For example, the RRM node may not command a UE to handover to a WLAN AP even if the WLAN signal strength is considered suitable, if the load, backhaul load, connection capability, and/or other aspect of the WLAN AP indicate possible congestion or near-congestion (or if the number of associated devices in that WLAN AP is already higher than a preconfigured threshold, or if the connection capability shows the WLAN AP as not suitable for the UE). In the case of idle mode, the cellular network/RRM node may remove a congested WLAN AP from neighboring cell information (or may add the congested WLAN AP to a blacklist of target cells/APs) to avoid idle mode devices from camping/reselecting those congested WLAN APs.

In some example embodiments, WLAN APs are treated in the same way as cells of cellular RAN with respect to RRC measurement configuration, so the WLAN APs appear as measurement objects. However, the WLAN AP measurement objects further include for example BSS load, WAN metrics, capability information and/or any other relevant information available in the WLAN AP. The reporting criterion for the WLAN AP measurements may be periodical and/or event based. Alternatively or additionally, the basic measurement may only include the signal strength measurement, and the additional information may only be obtained by the UE when explicitly requested by the cellular RAN. In some example embodiments, the UE may obtain information from a WLAN AP without actually associating with the WLAN AP (for example, under IEEE 802.11u). The WAN metrics may be implemented in accordance with IEEE 802.11, so transmission characteristics, such as speed of the WAN connection to the Internet, load of downlinks, load of uplinks, may be obtained from the WLAN AP. In addition, the downlink load and uplink load may be implemented as a 1-octet positive integer representing the current percentage loading of the downlink/uplink WAN connection, scaled linearly with 255 representing 100%. The connection capability information element may provide information on the connection status of the WLAN AP within a hotspot. For example, a firewall upstream to the access network may allow communication on certain IP protocols and ports, while blocking communication on others. Furthermore, mathematical operations may be calculated on the WLAN measurements to make the measurements more comparable to RAN measurements.

In some example embodiments, the idle mode control of the WLAN APs may be handled in similar fashion to cellular RAN with respect to preventing the UE(s) from selecting certain WLAN RANs. For example, in the System Information Block (SIB) of RAN, certain WLAN APs in the coverage area could be blacklisted, as noted above, to prevent the UE(s) from selecting these certain WLAN AP if the recent load information indicates their load or their capability is not sufficient. SIB information may also be used for prioritizing WLAN APs in the vicinity of the radio cell. Similar operations as achieved by SIB signaling for all or any device in the cell, information can be provided to a single device or to a set of devices by dedicated RRC-signaling. Alternatively or additionally, the RRM entity may command the measurements of the WLAN RAN to determine availability of WLAN APs are for the UE at that point and determine the WLAN APs load, capability status, and other like information. This information may be available in the WLAN AP through for example an ANQP query, without the need for the UE to associate itself with the given AP. Moreover, a threshold may be specified to limit measurements of WLAN APs considered to be poor (for example, weak) targets. This approach may also allow construction of an access point map around a given cellular cell. The RRM entity may command specific UEs to measure specific APs to keep their load status/admission information sufficiently up to date (for example, in case the information needed for admission control is no longer up to date per some time criteria, a UE may get a command and/or a new measurement configuration, to specifically measure those WLAN APs).

The following provides additional example embodiments related to minimization of drive test (MDT). In some example embodiments, MDT measurements procedures are augmented to allow configuring the UE to obtain WLAN related information including measurements (which are in addition to the cellular RAN related measurements performed as part of MDT). In connected mode reporting for example, a measurement configuration parameter in a RRC Connection Reconfiguration message may be used to configure UE WLAN measurements and cellular RAN measurements. For example, the RRC Connection Reconfiguration message may be extended to add a WLAN measurement configuration that may also include measurement priorities.

In some example embodiments, a single trace configuration sent to a UE may include an MDT configuration for the cellular RAN, such as LTE RAN, and an indication requesting WLAN measurements as well. The measurement configuration may be signaled to the UE with an extended RRC measurement configuration message having an additional information element for the WLAN measurement configuration. Both cellular RAN and WLAN RAN measurement results may be reported using an extended measurement report. Reporting triggers may be limited to cellular RAN options as reporting may be performed via the LTE RAN. Alternatively or additionally, there may also be WLAN specific reporting triggers. For example, a WLAN/WiFi event may initiate MDT reporting over LTE RRC measurement reporting. In any case, the MDT report may be sent to the cellular RAN. There may be separate location information per MDT report per each radio access technology (for example, LTE RAN and WiFi RAN). The forwarding of the MDT reports to the trace reporting element (TCE) may be done using normal Trace signaling but the MDT report may include content extended with multi-RAN results and an indication regarding WLAN measurements.

In some example embodiments, the WLAN-related measurements configured for the UE may include one or more of the following: a channel load, a noise histogram, a beacon measurement, a frame measurement, a STA statistic, a location configuration indication (LCI), a traffic stream measurement, and the like. Additional aspects may include new features defined for measurement or roaming purposes, link measurement request and report frames, neighbor reporting request and response frames, pilot frame measurements, and the like. Although some of the possible WLAN-related measurements are described for WiFi, such as IEEE 802.11k, although other types measurements may be used as well.

In example embodiments where immediate MDT reporting is being used, the configuration may be based on an RRC measurement procedure to enable WLAN measurement configuration and reporting. The measurement reports requested of the UE may include location information, WLAN measurement priorities, and the like. The UE may follow the provided configuration request and add the requested information to a measurement report sent to the network.

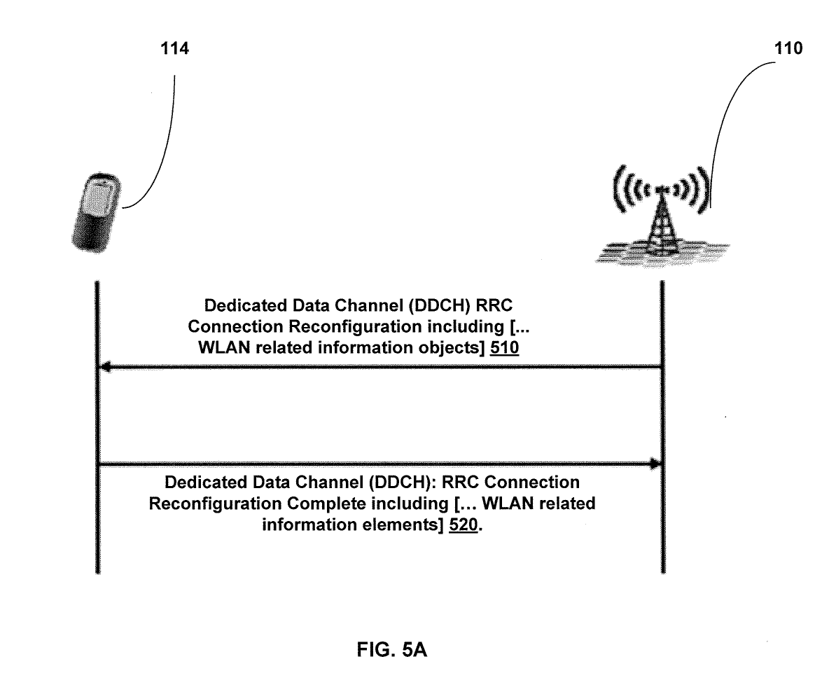

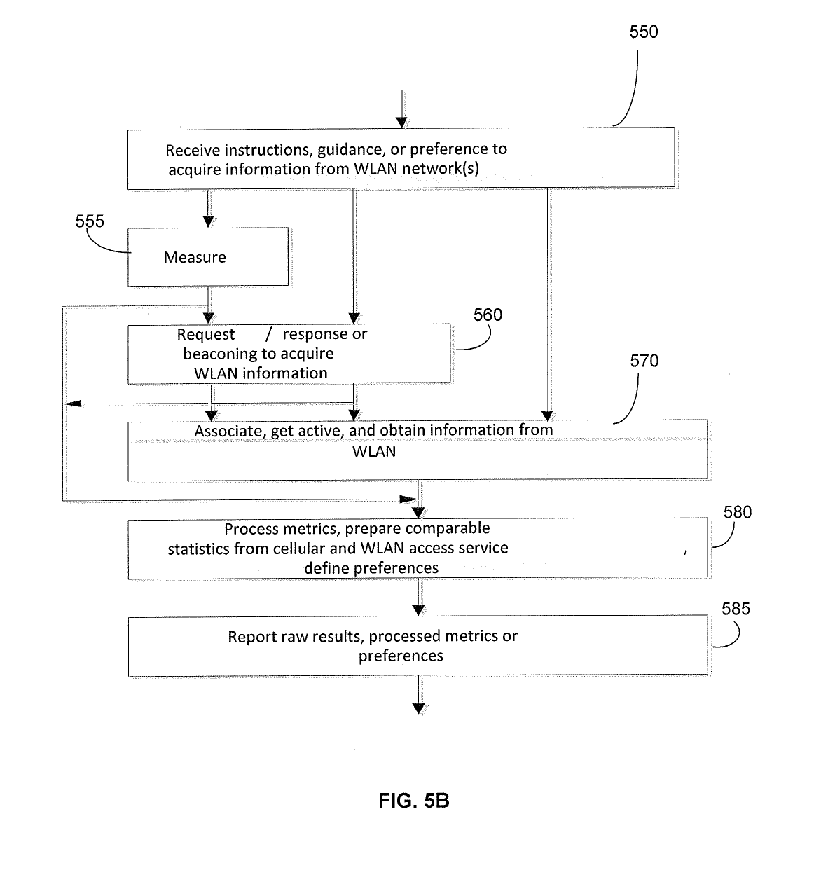

In example embodiments using connected mode MDT reporting, a measurement configuration parameter in a RRC Connection Reconfiguration message may be used to thus configure measurements in the UEs. The RRC Connection Reconfiguration procedure is depicted in FIG. 5A, in accordance with some example embodiments. The RRC Connection Reconfiguration message may, as noted, be extended to add the WLAN measurement configuration and WLAN measurement priorities.

Referring to FIG. 5A, the RRC connection reconfiguration message sent at 510 may be sent in response to a Trace procedure. The Trace configuration may be sent to the cellular RAN 110 (for example, a management based Trace) or the subscriber UE 114 (for example, signaling based Trace), and the configuration information or an information object sent at 510 may be augmented to include WLAN-related information, such as WLAN measurement configuration and/or cellular measurement configurations. The UE 114 may collect the measurement results and then reported the results to the network at 520 as a report provided as part of the RRC procedure. The WLAN measurement results provided at 520 may also include an identification of which measurements are WLAN measurements to allow distinguishing those WLAN measurements from cellular access point measurements. For example, the WLAN measurements sent at 520 may include a flag or other indicator associated with the WLAN measurement results, although specific information elements may be defined to distinguish the WLAN measurements from other information. In any case, the WLAN measurement results may be visible in the report sent at 520 over the cellular radio interface and forwarded from the cellular RAN 110 node to a management entity, such as a Trace data collection entity (TCE). The process described with respect to FIG. 5A may be used with connected and/or idle mode measurements as well.

In some example embodiments, the reporting at 520 may include one or more of the following: an AP channel report, an antenna information element, a BSS average access delay, a BSS available admission capacity, a BSS access delay, a measurement pilot transmission information element, a received channel power indicator (RCPI) element, a received signal noise indicator (RSNI) element, a neighbor report element, and/or any other measurement and/or WLAN related information.

FIG. 5B depicts an example process for reporting WLAN-related information to a cellular network, in accordance with some example embodiments. At 550, the user equipment may in accordance with some example embodiments, receive an instruction, a guidance, and/or a preference to acquire information from one or more wireless local area networks. The user equipment may, at 555, perform one or more measurements on wireless local area networks in accordance with some example embodiments. The user equipment may, at 560, acquire WLAN-related information by listening beacon and/or by requesting and then listening response transmitted by one or more wireless access points, in accordance with some example embodiments. The user equipment may, at 570, associate itself with one or more wireless access points of wireless access networks to obtain WLAN-related information as a STA associated with the wireless access network/access point, in accordance with some example embodiments. The user equipment may, at 580, process any of the WLAN-related information received at 555-570, in accordance with some example embodiments. This processing may, at 580, include generating statistics, filtering results, and/or the like, in accordance with some example embodiments. At 585, the user equipment may report to the cellular network WLAN-related information received at 555-570 as well as any processed information generated at 580. For example, user equipment (UE) may form based on the gathered information from WLAN(s) or by further processing the gathered information define preferences, so that it is feasible to just report these preferences instead of extensive measurement results to RAN.

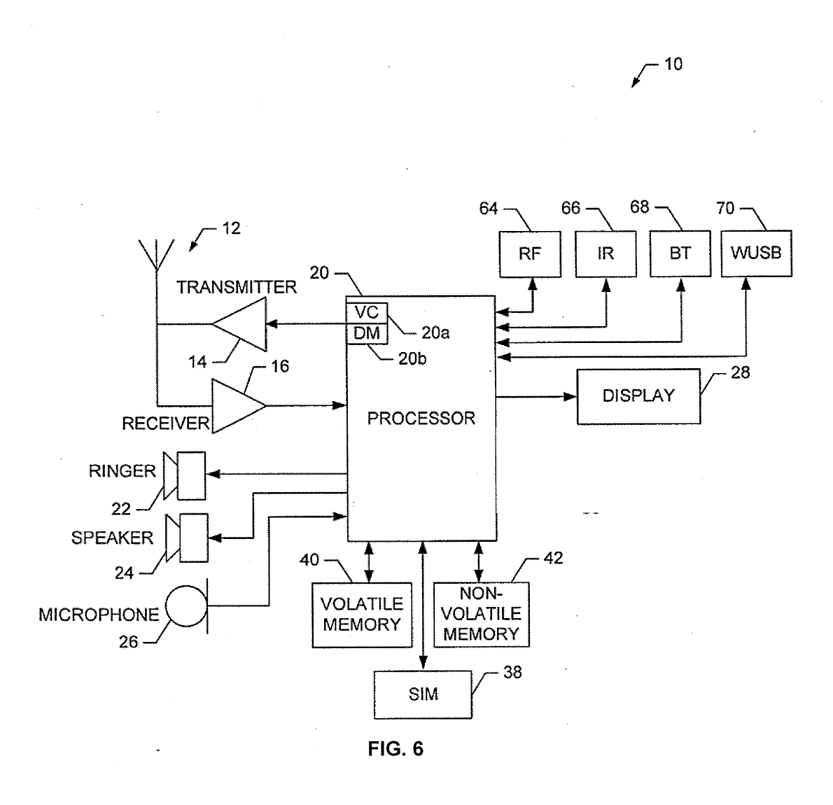

FIG. 6 illustrates a block diagram of an apparatus 10, which can be configured as user equipment in accordance with some example embodiments.

The apparatus 10 may include at least one antenna 12 in communication with a transmitter 14 and a receiver 16. Alternatively transmit and receive antennas may be separate. In some example embodiments, the apparatus 10 may be implemented as a multi-mode radio including a plurality of radio access technologies. When this is the case, apparatus 10 may include a plurality of radio frequency subsystems configured in accordance with a plurality of radio access technologies. For example, apparatus 10 may include antenna(s) (for example, antenna 12 described below), radio frequency components (for example, transmitter 14 and receiver 16 described below), and other devices configured to provide access to a cellular radio access network, such as Long Term Evolution and the like, and may further include another set of antenna(s), radio frequency components, and other devices configured to provide access to a wireless local area network using for example WiFi and the like.

The apparatus 10 may also include a processor 20 configured to provide signals to and receive signals from the transmitter and receiver, respectively, and to control the functioning of the apparatus. Processor 20 may be configured to control the functioning of the transmitter and receiver by effecting control signaling via electrical leads to the transmitter and receiver. Likewise processor 20 may be configured to control other elements of apparatus 10 by effecting control signaling via electrical leads connecting processor 20 to the other elements, such as for example, a display or a memory. The processor 20 may, for example, be embodied in a variety of ways including circuitry, at least one processing core, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits (for example, an application specific integrated circuit (ASIC), a field programmable gate array (FPGA), and/or the like), or some combination thereof. Accordingly, although illustrated in FIG. 6 as a single processor, in some example embodiments the processor 20 may comprise a plurality of processors or processing cores.

Signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques, such as for example, Institute of Electrical and Electronics Engineers (IEEE) 802.11, 802.16, and/or the like, or their combinations. In addition, these signals may include speech data, user generated data, user requested data, and/or the like.

The apparatus 10 may be capable of operating with one or more air interface standards, communication protocols, modulation types, access types, and/or the like. For example, the apparatus 10 and/or a cellular modem therein may be capable of operating in accordance with various first generation (1G) communication protocols, second generation (2G or 2.5G) communication protocols such as GERAN, GPRS or alike, third-generation (3G) communication protocols such as WCDMA, HSPA, cdma2000, TD-SCDMA or alike, fourth-generation (4G) communication protocols such as LTE, EUTRA, TD-LTE or alike, or evolved packet systems such as Internet Protocol Multimedia Subsystem (IMS) communication protocols (for example, session initiation protocol (SIP) and/or the like. The apparatus may also implement Internet protocols or their additions for IP flow mobility, or higher layer protocols as http, Skype, Youtube, Netflix, or alike. For example, the apparatus 10 may be capable of operating in accordance with 2G wireless communication protocols IS-136, Time Division Multiple Access TDMA, Global System for Mobile communications, GSM, IS-95, Code Division Multiple Access, CDMA, and/or the like. In addition, for example, the apparatus 10 may be capable of operating in accordance with 2.5G wireless communication protocols General Packet Radio Service (GPRS), Enhanced Data GSM Environment (EDGE), and/or the like. Further, for example, the apparatus 10 may be capable of operating in accordance with 3G wireless communication protocols, such as for example, Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The apparatus 10 may be additionally capable of operating in accordance with 3.9G wireless communication protocols, such as for example, Long Term Evolution (LTE), Evolved Universal Terrestrial Radio Access Network (E-UTRAN), and/or the like. Additionally, for example, the apparatus 10 may be capable of operating in accordance with 4G wireless communication protocols, such as for example, LTE Advanced and/or the like as well as similar wireless communication protocols that may be subsequently developed.

It is understood that the processor 20 may include circuitry for implementing audio/video and logic functions of apparatus 10. For example, the processor 20 may comprise a digital signal processor device, a microprocessor device, an analog-to-digital converter, a digital-to-analog converter, and/or the like. Control and signal processing functions of the apparatus 10 may be allocated between these devices according to their respective capabilities. The processor 20 may additionally comprise an internal voice coder (VC) 20a, an internal data modem (DM) 20b, and/or the like. Further, the processor 20 may include functionality to operate one or more software programs, which may be stored in memory. In general, processor 20 and stored software instructions may be configured to cause apparatus 10 to perform actions. For example, processor 20 may be capable of operating a connectivity program, such as for example, a web browser. The connectivity program may allow the apparatus 10 to transmit and receive web content, such as for example, location-based content, according to a protocol, such as for example, wireless application protocol, WAP, hypertext transfer protocol, HTTP, and/or the like.

Apparatus 10 may also comprise a user interface including, for example, an earphone or speaker 24, a ringer 22, a microphone 26, a display 28, a user input interface, and/or the like, which may be operationally coupled to the processor 20. The display 28 may, as noted above, include a touch sensitive display, where a user may touch and/or gesture to make selections, enter values, and/or the like. The processor 20 may also include user interface circuitry configured to control at least some functions of one or more elements of the user interface, such as for example, the speaker 24, the ringer 22, the microphone 26, the display 28, and/or the like. The processor 20 and/or user interface circuitry comprising the processor 20 may be configured to control one or more functions of one or more elements of the user interface through computer program instructions, for example, software and/or firmware, stored on a memory accessible to the processor 20, for example, volatile memory 40, non-volatile memory 42, and/or the like. The apparatus 10 may include a battery for powering various circuits related to the mobile terminal, for example, a circuit to provide mechanical vibration as a detectable output. The user input interface may comprise devices allowing the apparatus 20 to receive data, such as for example, a keypad 30 (which can be a virtual keyboard presented on display 28 or an externally coupled keyboard) and/or other input devices.

As shown in FIG. 6, apparatus 10 may also include one or more mechanisms for sharing and/or obtaining data. For example, the apparatus 10 may include a short-range radio frequency (RF) transceiver and/or interrogator 64, so data may be shared with and/or obtained from electronic devices in accordance with RF techniques. The apparatus 10 may include other short-range transceivers, such as for example, an infrared (IR) transceiver 66, a Bluetooth (BT) transceiver 68 operating using Bluetooth wireless technology, a wireless universal serial bus (USB) transceiver 70, and/or the like. The Bluetooth transceiver 68 may be capable of operating according to low power or ultra-low power Bluetooth technology, for example, Wibree, radio standards. In this regard, the apparatus 10 and, in particular, the short-range transceiver may be capable of transmitting data to and/or receiving data from electronic devices within a proximity of the apparatus, such as for example, within 10 meters, for example. The apparatus 10 including the WiFi or wireless local area networking modem may also be capable of transmitting and/or receiving data from electronic devices according to various wireless networking techniques, including 6LoWpan, Wi-Fi, Wi-Fi low power, WLAN techniques such as for example, IEEE 802.11 techniques, IEEE 802.15 techniques, IEEE 802.16 techniques, and/or the like.

The apparatus 10 may comprise memory, such as for example, a subscriber identity module (SIM) 38, a removable user identity module (R-UIM), a soft-SIM software module and/or the like, which may store information elements related to a mobile subscriber. In addition to the SIM, the apparatus 10 may include other removable and/or fixed memory. The apparatus 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices, for example, hard disks, floppy disk drives, magnetic tape, optical disc drives and/or media, non-volatile random access memory (NVRAM), and/or the like. Like volatile memory 40, non-volatile memory 42 may include a cache area for temporary storage of data. At least part of the volatile and/or non-volatile memory may be embedded in processor 20. The memories may store one or more software programs, instructions, pieces of information, data, and/or the like which may be used by the apparatus for performing functions of the user equipment/mobile terminal. The memories may comprise an identifier, such as for example, an international mobile equipment identification (IMEI) code, capable of uniquely identifying apparatus 10. The functions may include one or more of the operations disclosed herein with respect to the user equipment, such as for example, the functions disclosed at FIGS. 1-5 (for example, receive an indication to measure WLAN and obtain other WLAN related information for reporting to the cellular RAN and/or the like). The memories may comprise an identifier, such as for example, an international mobile equipment identification (IMEI) code, capable of uniquely identifying apparatus 10. In the example embodiment, the processor 20 may be configured using computer code stored at memory 40 and/or 42 to enable the user equipment to make measurements of a WLAN AP under the control of a cellular RAN and/or any other function associated with the user equipment or apparatus disclosed herein.

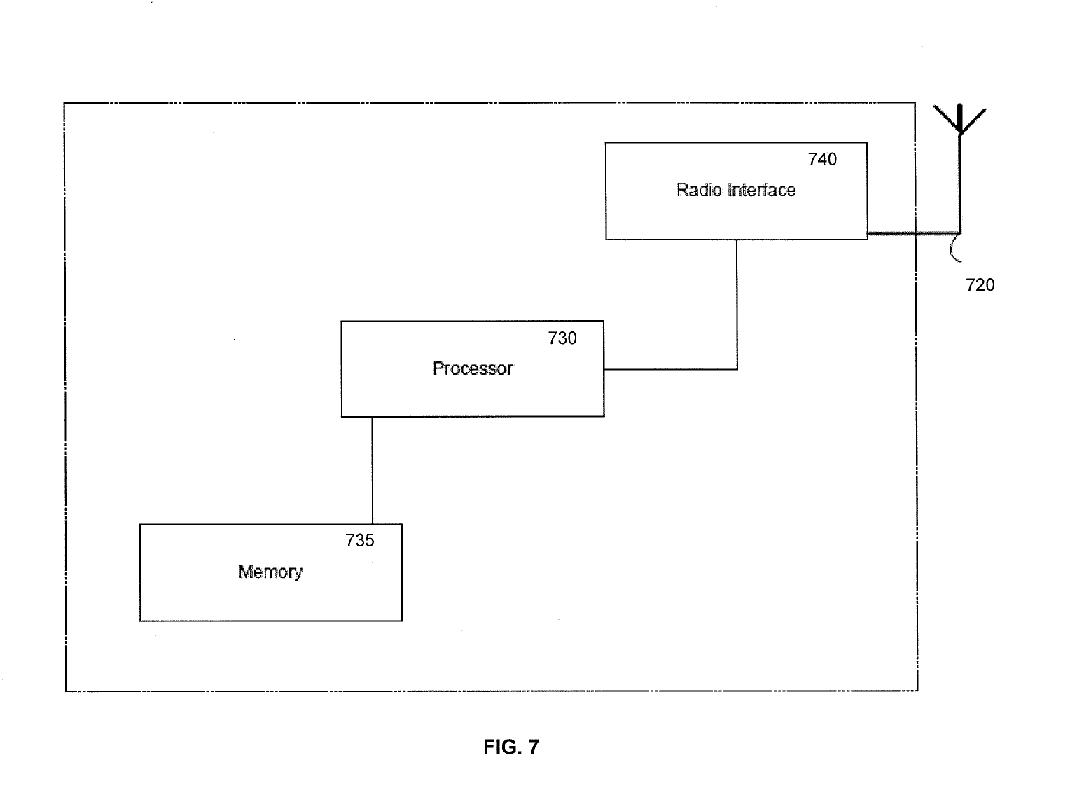

FIG. 7 depicts an example implementation of a network node, such as a cellular base station and/or a WLAN AP, or a combination thereof. The network node may include one or more antennas 720 configured to transmit via a downlink and configured to receive uplinks via the antenna(s) 720. The network node may further include a plurality of radio interfaces 740 coupled to the antenna 720. The radio interfaces may correspond one or more of the following: Long Term Evolution (LTE, or E-UTRAN), Third Generation (3G, UTRAN, or high speed packet access (HSPA)), Global System for Mobile communications (GSM), wireless local area network (WLAN) technology, such as for example 802.11 WiFi and/or the like, Bluetooth, Bluetooth low energy (BT-LE), near field communications (NFC), and any other radio technologies. The radio interface 740 may further include other components, such as filters, converters (for example, digital-to-analog converters and/or the like), mappers, a Fast Fourier Transform (FFT) module, and/or the like, to generate symbols for a transmission via one or more downlinks and to receive symbols (for example, via an uplink). The network node may further include one or more processors, such as processor 730, for controlling the network node and for accessing and executing program code stored in memory 735. In some example embodiments, memory 735 includes code, which when executed by at least one processor causes one or more of the operations described herein with respect to a base station and/or a wireless access point. For example, the network node may send configuration information to allow a UE to measure WLAN APs, receive reports including WLAN-related information, and/or perform any other operations related to a base station and/or a wireless access point.

Some of the embodiments disclosed herein may be implemented in software, hardware, application logic, or a combination of software, hardware, and application logic. The software, application logic, and/or hardware may reside on memory 40, the control apparatus 20, or electronic components, for example. In some example embodiment, the application logic, software or an instruction set is maintained on any one of various conventional computer-readable media. In the context of this document, a “computer-readable medium” may be any non-transitory media that can contain, store, communicate, propagate or transport the instructions for use by or in connection with an instruction execution system, apparatus, or device, such as for example, a computer or data processor, with examples depicted at FIGS. 6 and 7. A computer-readable medium may comprise a non-transitory computer-readable storage medium that may be any media that can contain or store the instructions for use by or in connection with an instruction execution system, apparatus, or device, such as for example, a computer. Moreover, some of the embodiments disclosed herein include computer programs configured to cause methods as disclosed herein (see, for example, FIGS. 1-5 and/or the like).

Without in any way limiting the scope, interpretation, or application of the claims appearing below, a technical effect of one or more of the example embodiments disclosed herein may enhance interworking by allowing the cellular RAN to configure the UE to perform WLAN related measurements.

If desired, the different functions discussed herein may be performed in a different order and/or concurrently with each other. Furthermore, if desired, one or more of the above-described functions may be optional or may be combined. Although various aspects of the invention are set out in the independent claims, other aspects of the invention comprise other combinations of features from the described embodiments and/or the dependent claims with the features of the independent claims, and not solely the combinations explicitly set out in the claims. It is also noted herein that while the above describes example embodiments, these descriptions should not be viewed in a limiting sense. Rather, there are several variations and modifications that may be made without departing from the scope of the present invention as defined in the appended claims. Other embodiments may be within the scope of the following claims. The term “based on” includes “based on at least.”

1-24. (canceled)

25. A method comprising:
receiving, at a user equipment, a request from a cellular radio access network to obtain information about a wireless local area network, wherein the request comprises at least one of a logged measurement configuration, a measurement configuration, or a trace procedure;
reporting, in response to the request, at least one of a measurement representative of a wireless local area network access point, a load experienced by the wireless local area network access point, or a capacity experienced by the wireless local area network access point; and
obtaining, by the user equipment, the information about the wireless local area network access point wherein an identity of the wireless local area network access point is provided by the cellular radio access network.

26. The method of claim 25, wherein the information includes at least one of the following: an idle channel measurement; beacon information obtained by listening to a beacon associated with the wireless local area network access point; report information obtained from the wireless local area network access point; and at least one statistic representative of the wireless local area network access point.

27. The method of claim 25, wherein the information is obtained in accordance with a station functionality of a wireless local area network.

28. The method of claim 25, wherein the reporting is performed periodically, on demand when requested, on a trigger of an event, or a combination thereof.

29. The method of claim 25, wherein the request comprises a radio resource control connection reconfiguration message including at least one instruction for the user equipment to obtain the information about the wireless local area network access point.

30. The method of claim 29, wherein the radio resource control connection reconfiguration message includes a measurement priority.

31. The method of claim 25, wherein the cellular radio access network provides at least one of a frequency band or a radio access technology representative of candidate wireless local area network access points.

32. The method of claim 25, wherein the reporting further includes at least one of a delay associated with the wireless local area network access point, a throughput associated with the wireless local area network access point, a backhaul load associated with the wireless local area network access point, and a backhaul offered bit rate associated with the wireless local area network access point.

33. An apparatus, comprising:
at least one processor; and
at least one memory including computer program code, the at least one memory and the computer program code configured to, with the at least one processor, cause the apparatus to perform at least the following:
receive a request from a cellular radio access network to obtain information about a wireless local area network, wherein the request comprises at least one of a logged measurement configuration, a measurement configuration, or a trace procedure;
report, in response to the request, at least one of a measurement representative of a wireless local area network access point, a load experienced by the wireless local area network access point, or a capacity experienced by the wireless local area network access point; and
obtain, by the apparatus, the information about the wireless local area network access point wherein an identity of the wireless local area network access point is provided by the cellular radio access network.

34. The apparatus of claim 33, wherein the information includes at least one of the following: an idle channel measurement; beacon information obtained by listening to a beacon associated with the wireless local area network access point; report information obtained from the wireless local area network access point; and at least one statistic representative of the wireless local area network access point.

35. The apparatus of claim 33, wherein the information is obtained in accordance with a station functionality of a wireless local area network.

36. The apparatus of claim 33, wherein the reporting is performed periodically, on demand when requested, on a trigger of an event, or a combination thereof.

37. The apparatus of claim 33, wherein the request comprises a radio resource control connection reconfiguration message including at least one instruction for the user equipment to obtain the information about the wireless local area network access point.

38. The apparatus of claim 37, wherein the radio resource control connection reconfiguration message includes a measurement priority.

39. The apparatus of claim 33, wherein the cellular radio access network provides at least one of a frequency band or a radio access technology representative of candidate wireless local area network access points.

40. The apparatus of claim 33, wherein the reporting further includes at least one of a delay associated with the wireless local area network access point, a throughput associated with the wireless local area network access point, a backhaul load associated with the wireless local area network access point, and a backhaul offered bit rate associated with the wireless local area network access point.

41. A non-transitory computer readable medium including computer code, which when executed by a computer processor provides operations comprising:
receiving a request from a cellular radio access network to obtain information about a wireless local area network, wherein the request comprises at least one of a logged measurement configuration, a measurement configuration, or a trace procedure;
reporting, in response to the request, at least one of a measurement representative of a wireless local area network access point, a load experienced by the wireless local area network access point, or a capacity experienced by the wireless local area network access point; and
obtaining the information about the wireless local area network access point wherein an identity of the wireless local area network access point is provided by the cellular radio access network.

42. The computer readable medium of claim 41, wherein the information includes at least one of the following: an idle channel measurement; beacon information obtained by listening to a beacon associated with the wireless local area network access point; report information obtained from the wireless local area network access point; and at least one statistic representative of the wireless local area network access point.

43. The computer readable medium of claim 41, wherein the information is obtained in accordance with a station functionality of a wireless local area network.

44. The computer readable medium of claim 41, wherein the reporting is performed periodically, on demand when requested, on a trigger of an event, or a combination thereof.
